(19) United States
(12) Patent Application Publication
(10) Pub. No.: US 2002/0116963 A1
(43) Pub. Date: Aug. 29, 2002

(54) Air bag retainer

(76) Inventor: Miko Lee, Hsin Chuang City (TW)

Correspondence Address: Kenneth F. Florek, Esq., Hedman & Costigan, PC, 1185 Avenue of the Americas, New York, NY, 10036, US

(21) Appl. No.: 10/015,358

(22) Filed: Dec. 13, 2001

Related U.S. Application Data
(63) Continuation-in-part of application No. 09/794,535, filed on Feb. 27, 2001, now Pat. No. 6,378,343.

(51) Int. Cl. F16C 3/00

(52) U.S. Cl. 70/209

(57) ABSTRACT

An air bag retainer to be used in combination with a steering lock for securing an air bag of an automobile while the steering lock secures the automobile. The air bag retainer includes a plate and a hooking portion extending from a side of the plate to hook a steering wheel of the automobile. Multiple through bores are defined in the other end of the plate so that connecting ends of the steering lock are able to respectively extend though the through bores to secure the air bag retainer to the steering wheel. Therefore, the air bag is securely covered by the plate and prevented from being stolen.

### CROSS REFERENCE

This is a continuation-in-part of the pending U.S. patent application Ser. No. 09/794,535 ('535) filed on Feb. 27, 2001 by the same applicant of this application. The information within the '535 application is hereinafter taken for reference and incorporated therewith.

### BACKGROUND OF THE INVENTION

1. Field of the Invention

The present invention relates to an air bag retainer such that an air bag of an automobile is prevented from being stolen.

2. Description of Related Art

Along with the automobile becoming a more and more important daily transportation vehicle now, various locking devices, such as locking devices for steering wheels, locking devices for gear change levers and locking devices for brakes, etc., have been devised in accordance with demand for prevention of theft.

The conventional locking devices of steering wheels sold on the market normally comprise a fork shaped body portion securely enclosing a wheel rim of a steering wheel, and a retaining rod extended outwards from the body portion. When an unauthorized person tries to steal an automobile, if the steering wheel is secured with the locking device, the retaining rod will be turned to abut a window of the automobile and thus the vehicle cannot be unauthorizedly driven away. However, the conventional locking device for a steering wheel has a defect which is that if a section of the wheel rim enclosed in the locking device is cut away, then the locking device with the section of the wheel rim can be removed and separated from the steering wheel, and the steering wheel will be still operable.

Therefore, the applicant has previously filed the U.S. patent application Ser. No. 09/794,535 and disclosed a locking device for a steering wheel of an automobile to overcome the mentioned defect. The locking device includes a body, a moving rod extendable from the body, and a holding portion integrally formed in the body. A holding member is further securely mounted at a distal end of the moving rod so that a nodal point of the steering wheel can be enclosed between the holding portion and the holding member in a locking status. Even if a thief attempts to remove the locking device by cutting a wheel rim of the steering wheel, as the nodal point is, at the same time, integrally formed with a wheel arm, the locking device securely enclosing the nodal point is still not separable from the steering wheel, and thus the thief is thwarted.

Although the locking device previously invented by the applicant is able to prevent the automobile from being stolen, it is not able to prevent an air bag located in the center of the steering wheel from being stolen. Recently, some thieves would rather easily steal the air bag instead of troublesomely breaking the locking device to steal the entire automobile. This is because the technology involved in making the air bag is very advanced and once a bag has been deployed, the replacement of the bag is very costly. Thus, there is a market for stolen air bags.

Accordingly, the present invention intend to provide an air bag retainer to mitigate and/or obviate the aforementioned problems.

### SUMMARY OF THE INVENTION

An objective of the preset invention is to provide an air bag retainer for securing an air bag of an automobile. The air bag retainer when used in accompaniment with a steering lock is able to secure the air bag while the steering lock reliably secures the automobile.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an air bag retainer in accordance with the present invention;

FIG. 2 is a side view of the air bag retainer in FIG. 1;

FIG. 3 is a perspective view of a steering lock disclosed in the U.S. patent application Ser. No. 09/794,535;

FIG. 4 is a schematic, plane view showing the steering lock and the air bag retainer before locked onto to a steering wheel of the automobile; and

FIG. 5 is a partially cross-sectional view showing the steering lock and the air bag retainer when locked onto the steering wheel.

### DETAILED DESCRIPTION OF THE PREFERRED EMBODIMENT

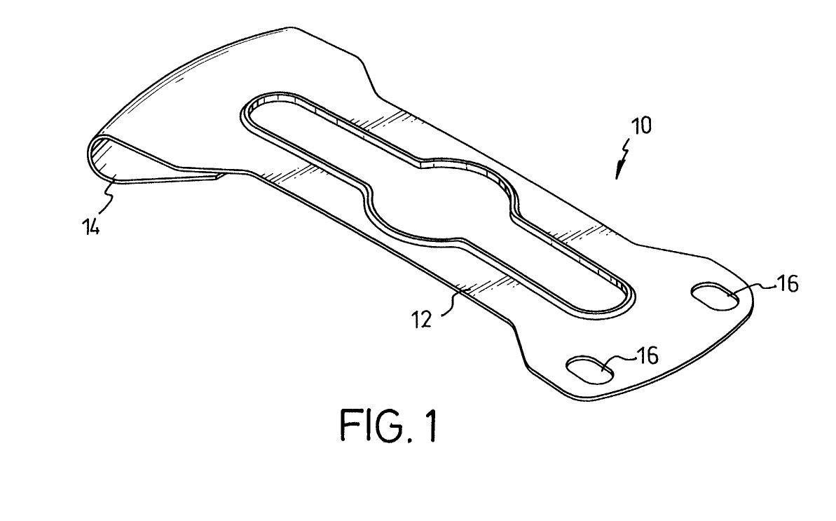

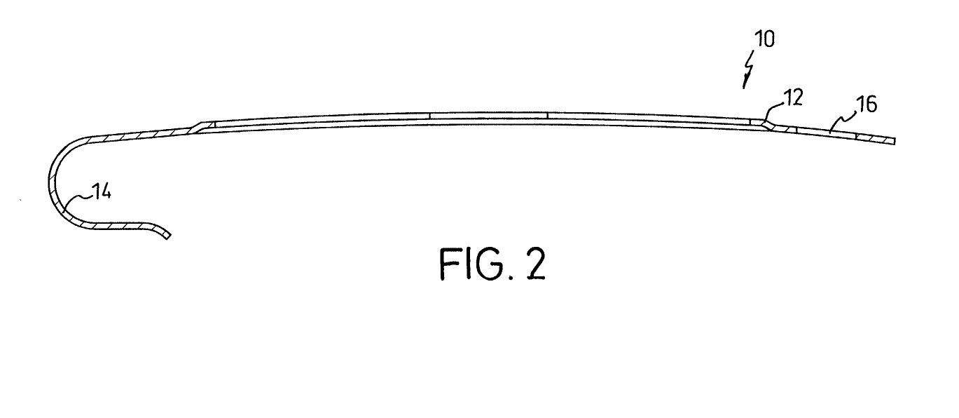

With reference to FIGS. 1 and 2, an air bag retainer (10) in accordance with the present invention has a plate (12). A hooking portion (14) is integrally formed with and extending from a side of the plate (12) in a bent manner to have a hook-like configuration if viewed from a side of the air bag retainer (10). Two through bores (16) are substantially defined at an opposed side of the plate (12) with respect to the hooking portion (14), and spaced at a proper distance.

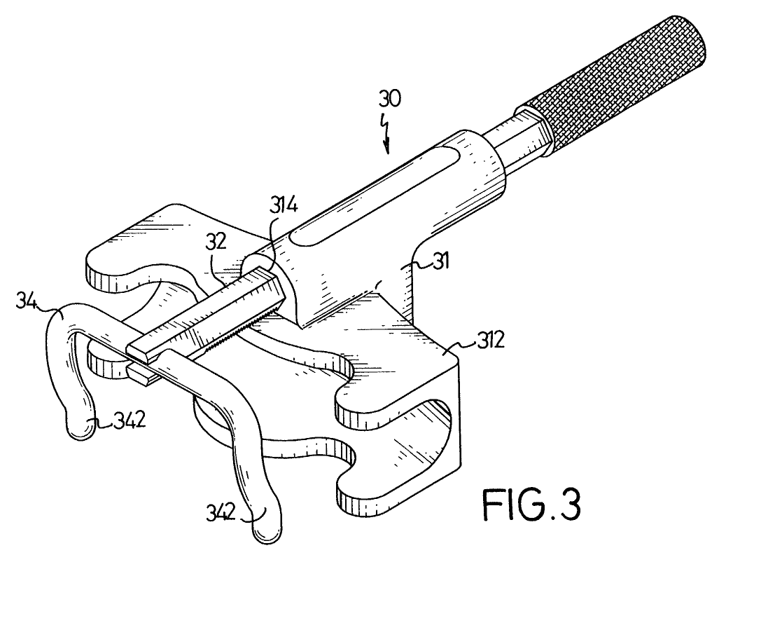

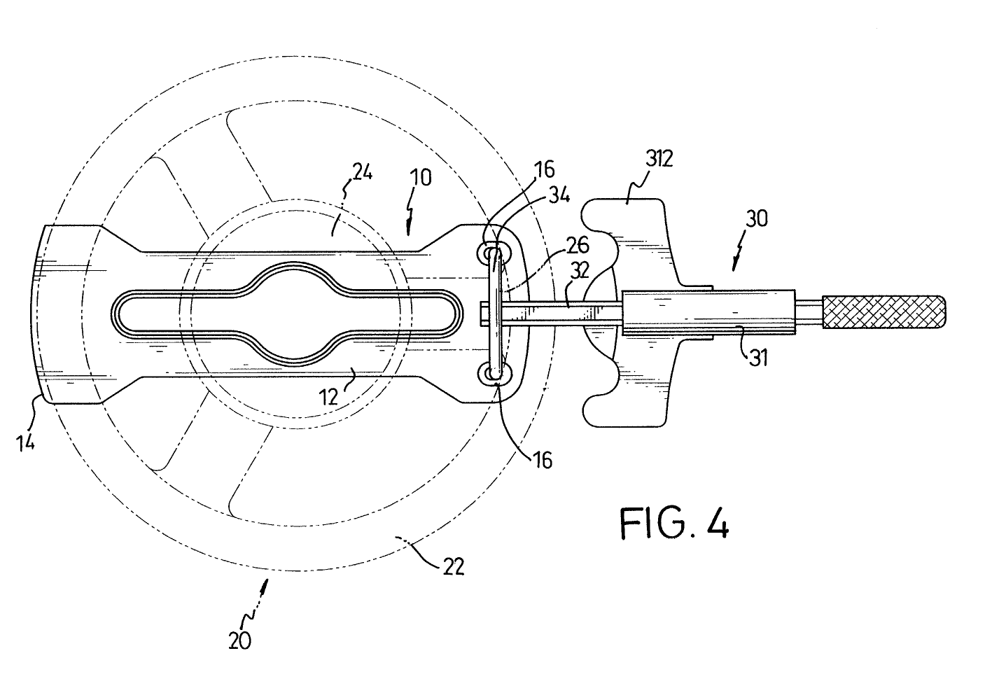

With reference to FIGS. 3 and 4, a steering lock (30) disclosed in the U.S. patent application Ser. No. 09/794,535 has a body (31). A retaining portion (312) is integrally formed with the body (31) and having a reversed C-shaped cross-section to receive a wheel rim (22) of a steering wheel (20). A moving rod (32) movably extends along a though hole (314) defined in the body (31). A retaining member (34) having an inverted U-shape is securely mounted at a free end of the moving rod (32), and has two connecting ends (342) downwardly extending and configured to be respectively extendable through the bores (16) defined in the plate (12). It should be appreciated that the steering lock (30) has been fully disclosed in the U.S. patent application Ser. No. 09/794,535 and therefore detailed description regarding the steering lock (30), especially regarding the locking mechanism inside the steering lock (30), is omitted.

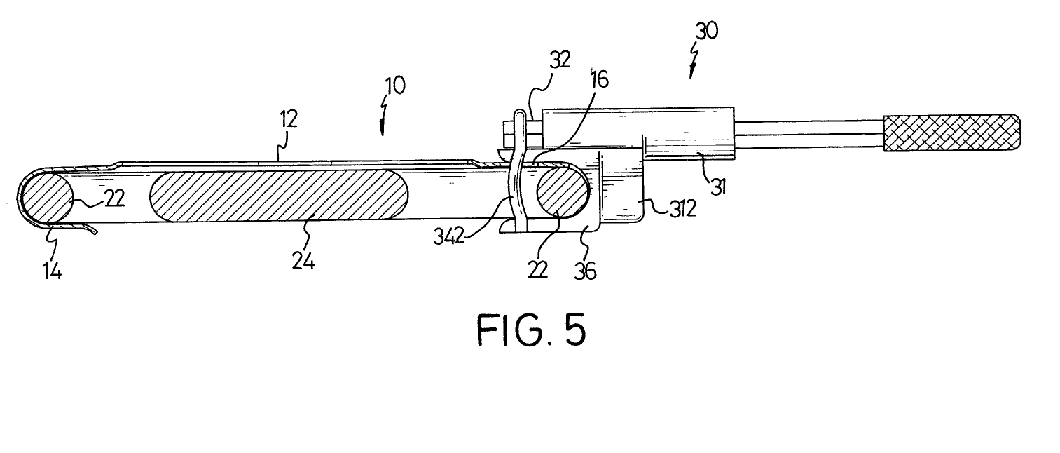

With reference to FIGS. 4 and 5, when using the air bag retainer (10) and the steering lock (30), the plate (12) of the air bag retainer (10) is placed on the steering wheel (20) and covers an air bag (24) located in the center of the steering wheel (20). The hooking end (14) of the plate (12) hooks to the wheel rim (22). At the same time, the other end of the plate (12) having the through bores (16) covers a nodal point (26) of the steering wheel (20) such that the nodal point (26) locates between the through bores (16). The two connecting ends (342) of the retaining member (34) next respectively extend through the through bores (16) to abut against an inner surface of the wheel rim (22) at two opposite sides of the nodal point (26). The body (20) can be pushed to move toward the holding member (34) till the nodal point (26) of the steering wheel (20) is wholly fitted in the holding portion (312) and the steering lock (30) is further set to a locking state. At this moment, the steering lock (30) is securely locked onto the steering wheel (20), while the air bag retainer (12) securely covers the air bag (24).

Therefore, from the above description, it is noted that the steering lock (30) in combination with the air bag retainer (10) have the advantages of not only being able to reliably secure the steering wheel (20) to prevent any unauthorized person from controlling the automobile, but also the air bag (24) is, at the same time, secured by the air bag retainer (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An air bag retainer adapted to detachably connect to a steering lock having a body, a moving rod movably extending from the body, a retaining member securely mounted at a distal end of the moving rod, a retaining portion formed in the body so that the retaining member together with the retaining portion are able to securely lock a steering wheel of an automobile in position, the air bag retainer comprising:
a plate adapted to detachably connect to the retaining member so as to cover an air bag of the automobile, the plate having a hooking portion formed on one end of the plate to adapt to hook the steering wheel, multiple through bores defined in the other end of the plate to correspond to the connecting ends of the retaining member of the steering lock so that the connecting ends are able to respectively extend though the through bores to secure the plate to the steering wheel.

2. The steering lock as claimed in claim 1, wherein a number of the multiple through bores is two so as to correspond to a number of the connecting ends of the retaining member.
